(19) United States
(12) Patent Application Publication
(10) Pub. No.: US 2008/0152395 A1
(43) Pub. Date: Jun. 26, 2008

(54) EQUIPMENT FOR FILLING DIFFERENT CONTAINERS OR LASER JET PRINTER CARTRIDGE WITH POWDER TONER BY MEANS OF A VACUUM CHAMBER AND ITS RESPECTIVE OBTAINMENT PROCESS

(76) Inventor: Luciano Piquet Da Cruz, Joao Pessoa (BR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/961,491

(22) Filed: Dec. 20, 2007

(30) Foreign Application Priority Data
Dec. 22, 2006 (BR) PI06060480

(51) Int. Cl. G03G 15/08; G03G 15/00

(52) U.S. Cl. 399/262; 399/109

(57) ABSTRACT

Equipment and process for filling containers or toner cartridges with powder toner is provided. Equipment capable of filling with toner powder different containers that may be PET bottle, plastic containers and some type of laser jet toner cartridge is through a vacuum process by removing the existent air in a transparent acrylic chamber in which the container is which is intended to be filled with the powder. The equipment includes a reservoir of stainless steel that holds a great amount of toner powder is arranged above the vacuum chamber. A scale is disposed within the vacuum chamber upon which the container or laser jet cartridge to be filled with toner powder rests. By the activation of a vacuum, generated by a motor, the air inside the chamber is evacuated and the container that is inside the chamber, causing the toner powder to be sucked in the reservoir inside the container.

### FIELD OF INVENTION

The present invention refers to equipment capable of filling with toner powder different containers that may be a PET bottle, plastic containers and some type of laser jet toner cartridge (the ones that allow vertical filling) through vacuum process removing the existent air in a transparent acrylic in which the container is which is intended to be filled with the powder.

### BACKGROUND

Laser jet printers recycling is today a technological and commercial reality worldwide as well as a totally legal activity. The more and more emergent ecological and environmental culture in addition to economical aspects makes this activity field to be strongly consolidated.

The filling of different containers and empty toner cartridge to be used in laser jet printers occurs in small amounts and specific for each different model. The fact is that the manufacture companies of toner powder sell this product in large amounts (usually set in plastic bags called BAG) so that the recyclers make fragment of them in small powder portions or even fill the laser jet printers empty cartridges. This process of dividing the powder that comes in Bags in small portions is highly problematic, due to the diameter of the powder articles that are 5 microns in average being, thus, very light and easily air dissipating. At transferring such powder from big Bags to the cartridges or smaller containers, great amount of such powder disperses through the environment making it dirty and bringing problems to the recycler health in case he/she is not using proper accessories for handling with it, such as a mask.

In the current market there are machines generally called PACKER, which fill the smaller containers and toner cartridges. Such equipments make the process of filling through powder injection making it disperse in the environment through suspended particles by being transferred from the machines to the container to be filled. Such machines, due to the use of mechanical processes when being filled, agitate even more the powder particles. In the end, all the known processes of filler spread powder in the working place, making it dirty and bringing problems to the health to the ones there working. The present invention aims at avoiding the inconvenient of the technique abovementioned, thus presenting equipment capable of filling generic containers through vacuum process, such filling technique creates a vacuum inside a chamber wherein it is found the container that is intended to be filled. The vacuum formed in the chamber sucks the powder that is found in the storage reservoir (BAG) and does not allow it to pollute the environment, due to the whole process occurs inside a closed chamber having no air movement.

### SUMMARY

The present invention is directed to equipment for filling containers, particularly laser jet printer cartridges. The equipment includes a transparent acrylic vacuum chamber and a stainless steel reservoir, arranged above the vacuum chamber. A scale having an electronic display is disposed within the vacuum chamber. The equipment also includes a vacuum generator motor connected to the vacuum chamber.

The present invention also is directed to a process for filling containers, particularly empty toner cartridges. The process includes placing the cartridge to be filled with toner powder on a scale inside an acrylic chamber and activating a vacuum pump to remove air from inside the chamber and the cartridge. The process further includes opening a first passage register to allow the flow of toner powder from a reservoir, by action of a vacuum created in the chamber. After the scale indicates the desired amount of toner powder the first register is closed and a second register is opened to break the vacuum and to allow the opening of the vacuum chamber door and the consequent removal of the cartridge.

### BRIEF DESCRIPTION OF THE DRAWING

FIG. 1, is a schematic depiction of a front view of the equipment of the present invention.

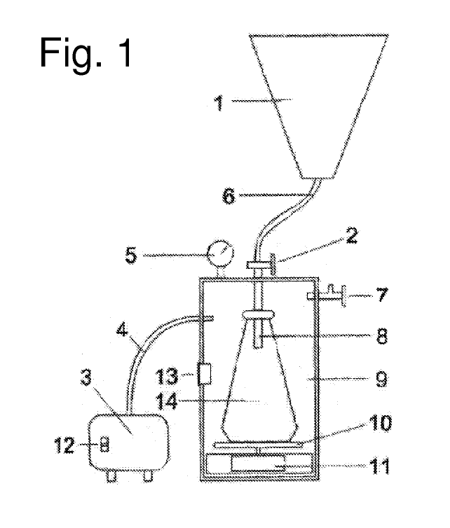

### DETAILED DESCRIPTION OF THE PREFERRED EMBODIMENT

According to what may be observed through such FIGURE, the equipment to fill different containers, object of the present invention, has as main elements a reservoir (1) of stainless steel resistant to chemical composition of toner powder, that must be put in a level above the vacuum chamber made of transparent acrylic (9), a scale (10) with an electronic display (11) and a vacuum generator motor (3). The system also comprises: two hoses, a hose (6) that connects the stainless steel reservoir (1) a vacuum chamber (9) and another hose (4) that makes the connection of the same chamber of the vacuum pump (3). Two registers control: the powder toner passage (2) and the chamber decompression (7). The system is activated by a power key (12) installed in the vacuum motor that, after turned on, removes the air inside the chamber that is shown in a vacuum gauge (5). A hinge (13) controls the chamber door closing mechanism. The container to be filled (14) is on the scale (10) and receives a PVC nozzle (8) in its mouth wherein it will receive the toner powder.

For the container filling (14), wherein it is intended to put a certain amount of toner powder that is intended to be put a certain amount of toner powder that is measured in grams, initially fills the reservoir (1) with the powder in great amount, the recipient to be filled (14) is put on the scale (10) making the PVC nozzle (8) to be inserted in it. The two passage registers (2) and (7) must be kept closed. After that, the vacuum chamber door is closed (9), that is safe by a hinge (13) and the switch (12) of the vacuum pump (3) that is connected to the vacuum chamber (9) by a hose (4) is turned on. In few seconds, the vacuum gauge indicator (5) indicates the air inside the vacuum chamber (9) has already been removed, thus forming the vacuum. When it happens, it is already possible to open the passage register (2) that connects the reservoir (1) to the chamber (9) by a hose (6). With this operation, the powder that is found in the reservoir (1) is sucked inside the container (14) that is intended to be filled. During the container filler, the powder amount is registered in the scale display (11) and, when it indicates the amount of powder intended to be filled, closes the register of the powder passage (2) immediately cutting its flow. It turns off the vacuum powder (3) through the switcher (12) and the decompression register (7) slowly opens so that the air enters the vacuum chamber (9). It allows the chamber door (9) to be open since the vacuum inside the chamber is what maintains it closed. After this cycle, the decompression register (7) closes and the container (14) that was filled with powder is removed. To fill a new container, the abovementioned operation is repeated, but not necessarily to fill the reservoir with powder (1) that, most of times, has enough toner powder for several filler cycles.

Thus, it may be concluded that the present invention, equipment for filling different containers or laser jet printer cartridge with powder toner by a vacuum chamber and its respective obtainment process, by its innovation relation has all of the needed conditions to apply for a patent.

What is claimed is:

1. Equipment for filling containers, particularly laser jet printer cartridges, the equipment comprising:
a transparent acrylic vacuum chamber;
a stainless steel reservoir, arranged above the vacuum chamber;
a scale having an electronic display disposed within the vacuum chamber; and
a vacuum generator motor connected to the vacuum chamber.

2. The equipment according to claim 1, further comprising:
a first hose connecting the stainless steel reservoir to the vacuum chamber;
a second hose that connects the vacuum chamber to the vacuum pump;
a first register, disposed between the reservoir and a PVC nozzle connected to a cartridge to be filled, that controls powder toner flow from the reservoir to a cartridge; and wherein the chamber comprises:
a second register that controls chamber decompression;
a vacuum gauge connected to the vacuum chamber, which indicates the amount of air inside the chamber; and
a hinge that controls a chamber door closing mechanism.

3. A process for filling containers, particularly empty toner cartridges, the process comprising the following steps:
placing the cartridge to be filled with toner powder on a scale inside an acrylic chamber;
activating a vacuum pump to remove air from inside the chamber and the cartridge;
opening a first passage register allowing the flow of toner powder from a reservoir, by action of a vacuum created in the chamber;
closing the first passage register after the scale indicates the desired amount of toner powder;
opening a second register to break the vacuum and to allow the opening of the vacuum chamber door and the consequent removal of the cartridge.
